(19) United States
(12) Patent Application Publication
(10) Pub. No.: US 2020/0093677 A1
(43) Pub. Date: Mar. 26, 2020

(54) Multifunctional hand rehabilitation training device

(71) Applicant: Chi Pong MAK, Hong Kong (HK)

(72) Inventor: Chi Pong MAK, Hong Kong (HK)

(21) Appl. No.: 16/175,808

(22) Filed: Oct. 30, 2018

(30) Foreign Application Priority Data
Sep. 20, 2018 (CN) 201811102158.4

(51) Int. Cl. A61H 1/02

(52) U.S. Cl. CPC A61H 1/0288; A61H 1/0285; A61H 2001/0203; A61H 2201/165; A61H 2201/1215; A61H 2201/5012; A61H 2201/5023; A61H 2201/5071; A61H 2201/5064; A61H 2201/1671; A61H 2201/1638; A61H 2201/5061

(57) ABSTRACT

The present invention discloses a multifunctional hand rehabilitation training device comprising robotic fingers, palm rods, a robotic wrist and a power control system: the robotic fingers correspond to human fingers. Each robotic finger comprises knuckles. Adjacent knuckles are hinged with a single degree of freedom to form a finger joint. Each finger joint is provided with a first servo motor which drives the knuckles to rotate about the hinge axis. Each knuckle is provided thereon with a collar for fitting over the knuckle of a human finger. The STM32F107VC under the ARM-Cortex-M3 architecture is used as the main controller. The main controller implements the acquisition of signals fed back by a fingertip outer side pressure sensor, a fingertip inner side pressure sensor and a linear sensor embedded in the first servo motor, the second servo motor, the third servo motor and the fourth servo motor. The finger abduction force detection sensor of the present invention detects the pressure on the outer side surface of a finger when the finger is stretched, and is used for detecting the motion intention of a patient to actively stretch the finger.

### FIELD OF THE INVENTION

The present invention relates to a human body exercise rehabilitation device, in particular to a multifunctional hand rehabilitation training device.

### BACKGROUND

Brain damage (stroke, cerebral palsy, brain trauma and brain tumors) is a major disease that threatens human health nowadays, with high mortality and disability rates. According to statistics, there are about 24.22 million people with physical disabilities and 10 million people with stroke in China, and the number increases by 4 million every year. Motor dysfunction is typically manifested as a physical impairment. Since the upper limb is responsible for a large number of fine movements, the recovery of its functions after injuries is more difficult. Permanent disability can be easily caused, bringing serious impacts on the patients' daily life.

As another application of robotics technology in the medical field, the rehabilitation robot is a product which combines rehabilitation theories with robotics technology. It has now become a research hotspot in the field of robotics. Rehabilitation robotic hands are an important branch of rehabilitation robots. Their main task is to assist patients with hand injuries in rehabilitation training. They can accomplish complicated tasks of traditional physiotherapists and help patients recover the motor function of injured fingers more rapidly.

Clinical studies have shown that rehabilitation training can prevent muscle spasms and improve joint mobility. Currently, the rehabilitation treatment for stroke patients are mostly physical therapies (e.g. acupuncture, electric stimulation and massage), which has certain curative effect. In the course of treatment, patients are passively treated only and their active participation is not guaranteed. Another option is medication, which is relatively simple. Not only is this method labor-intensive and expensive, but also the efficiency and intensity of training cannot be guaranteed. There lacks objective data for evaluating the relationship between the training parameters and the rehabilitation effects. It is difficult to optimize the training parameters to obtain the optimal treatment regimen. Therefore, for passive or active rehabilitation of patients, an instrument for finger movement is needed. Existing rehabilitation robots, however, train the movement of larger joints (e.g. shoulder joint, elbow joint and wrist joint) of the patients. Not every important joint, in particular the hand, is trained. The hand is responsible for numerous fine movements in daily life, with more joints and higher flexibility. Therefore, recovery of the hand is essential. However, most of the upper limb rehabilitation equipment neglect this point and lack rehabilitation training for finger coordination.

In a patent, a mechanism with four connecting rods is used to pull the end of the fingers. While driving the fingers to flex, it also imposes a pulling pressure on them in the radial direction, which is likely to cause finger injuries. The finger driving device is an important part of the structure of a rehabilitation robotic hand. To avoid extra damage to the injured fingers during rehabilitation, it must be ensured that the passive movement of the fingers during rehabilitation fits the natural movement of human fingers as much as possible, i.e. the movement trajectory of the finger driving mechanism should match with the natural movement trajectory of human fingers as much as possible. Studies have shown that when a human finger moves naturally, the movements of three finger joints have a definite relationship. Therefore, by selecting an appropriate gear ratio for the movement between the three joints, a mechanism with a single degree of freedom can be used to simulate the natural movement of a human finger.

A patent titled “A wearable exoskeleton robotic hand for rehabilitation training” discloses a robotic device that can be worn on a patient's hand for rehabilitation. By driving a first connecting rod mechanism and a second connecting rod mechanism to move with a driving mechanism, a four finger rehabilitation mechanism and a thumb rehabilitation mechanism are driven to move, achieving the purpose of rehabilitation. However, since the thumb and the other four fingers have a different swinging dimension spatially, a big technical problem exists when designing the thumb rehabilitation mechanism in practice.

In addition, existing finger rehabilitation devices involve the movement of some large joints of a patient, lacking close attachment to each important joint of each finger and a reasonable spatial arrangement for the entire finger. They are also designed to be driven by external forces such as motors and cylinders. There is still a safety hazard resulting in hand injuries.

In view of the shortcomings in the prior art, it is necessary to provide a device with novelty, practicality and inventiveness.

### SUMMARY

In order to solve the problems existing in the prior art, the purpose of the present invention is to provide a multifunctional hand rehabilitation training device, thereby solving the existing problems of expensive costs, uncertain training efficiency and strength, etc. The present invention adopts a structure which corresponds to a human hand. During the rehabilitation process, the finger joints and wrist joints are guided to perform corresponding movements in all degrees of freedom that a human hand has. While exercising the joints, the invention helps reduce the formation of scars, maximize skin elasticity, and therefore restore the functions of a recovered palm back to normal. During treatment, the fingers can be separated by a variable distance. At the same time, the formation of webbed scars between fingers can be reduced or suppressed, retaining the function of the hand to the maximum extent. The use of thick gauze to wrap the fingers is avoided to prevent prolonged recovery of the burned finger skin due to low breathability. The treatment cost is reduced as the pain of the burned patient is relieved. The finger abduction force detection sensor detects the pressure on the outer side surface of a finger when the finger is extended, and is used for detecting the movement intention of a patient to actively extend the finger. The finger flexion force detection sensor detects the pressure on the inner side surface of a finger when the finger flexes, and is used for detecting the movement intention of a patient to actively flex the finger. The main controller drives the hand to move according to a preset movement range and the signals of a displacement sensor embedded in the servo motors. When in the active rehabilitation training mode, the main controller implements data acquisition of the finger abduction force detection sensor and the finger flexion force detection sensor, and determines the movement intention of the finger according to the acquired signals, thereby driving the servo motors to extend or retract accordingly.

The technical solution adopted by the present invention is as follows: a multifunctional hand rehabilitation training device comprising robotic fingers, palm rods, a robotic wrist and a power control system. The robotic fingers correspond to human fingers. Each robotic finger comprises knuckles. Adjacent knuckles are hinged with a single degree of freedom to form a finger joint. Each finger joint is provided with a first servo motor which drives the knuckles to rotate about the hinge axis: each knuckle is provided thereon with a collar for fitting over the knuckle of a human finger.

The palm rods correspond to the robotic fingers. A front end of each palm rod is hinged to a back end of the robotic fingers with a single degree of freedom to form a whole finger joint: each whole finger joint is provided with a second servo motor which drives the robotic fingers to rotate about the hinge axis.

The robotic wrist comprises a palm support and a fixed arm. The palm support and the fixed arm are hinged with a single degree of freedom to form a wrist joint. The wrist joint is provided with a third servo motor which drives the palm support to rotate about the hinge axis. The fixed arm is provided thereon with a fixing ring for fixing the fixed arm onto a human arm.

A back end of the palm rods is hinged on the palm support with a single degree of freedom in a manner enabling rotation in the plane on which the palm is positioned, and is provided with a fourth servo motor which drives the palm rods to rotate about the hinge axis.

The first servo motor, the second servo motor, the third servo motor and the fourth servo motor pass through the power control system.

The left and right ends of the collar are respectively provided with a finger abduction force detection sensor and a finger flexion force detection sensor.

The power control system comprises a main controller connected to the first servo motor, the second servo motor, the third servo motor and the fourth servo motor. The STM32F107VC under the ARM-Cortex-M3 architecture is used as the main controller. The STM32F107 has a full-speed USD (OTG) interface, a duplex CAN2.0B interface and an Ethernet 10/100MAC module. The main controller implements the acquisition of signals fed back by a fingertip outer side pressure sensor, a fingertip inner side pressure sensor and a linear sensor embedded in the first servo motor, the second servo motor, the third servo motor and the fourth servo motor, and drives the first servo motor, the second servo motor, the third servo motor and the fourth servo motor to move according to the acquired signals. A signal conditioning unit in the main controller is used for processing signals from the fingertip outer side pressure sensor, the fingertip inner side pressure sensor and a displacement sensor embedded in the first servo motor, the second servo motor, the third servo motor and the fourth servo motor, and sending the processed signals to an acquisition board for data acquisition.

As a preferred technical solution, a thin-film piezoresistive sensor is used as the finger abduction force detection sensor and the finger flexion force detection sensor.

As a preferred technical solution, the inner circular surface of the collar is provided with a flexible thin layer.

As a preferred technical solution, the collar and fixing ring are of an open ring structure. Both sides of the opening are bent outward to form two bent portions. A screw is disposed through the two bent portions for sealing and adjusting the diameter of the collar. The fixing ring is of an open ring structure. Both sides of the opening are bent outward to form two bent portions. A fixing ring screw is disposed through the two bent portions for sealing and adjusting the diameter of the fixing ring.

As a preferred technical solution, the knuckles of the robotic fingers and the palm rods are of a telescopic structure composed of sleeves. The sleeves comprise an inner sleeve and an outer sleeve, provided with a locking screw screwing through the outer sleeve in the radial direction.

As a preferred technical solution, the fixed arm is fixedly connected to the fixing ring in a removable manner: the fixing ring is provided with two opposite connecting portions in the radial direction for fixed connection with the fixed arm.

As a preferred technical solution, the control system further comprises a display for displaying information of the first servo motor, the second servo motor, the third servo motor and the fourth servo motor, and a printing output device. The first servo motor, the second servo motor, the third servo motor and the fourth servo motor are connected to the power source through a controller.

As a preferred technical solution, adjacent knuckles of the robotic fingers are hinged through a motor shaft of the first servo motor with a single degree of freedom to form a finger joint. The housing of the first servo motor is fixed to one of the knuckles. The motor shaft of the first servo motor is fixedly fitted with another knuckle in the circumferential direction. A front end of the palm rods and a back end of the corresponding robotic fingers are hinged through a motor shaft of the second servo motor with a single degree of freedom to form a whole finger joint. The housing of the second servo motor is fixed to the palm rods. The motor shaft of the second servo motor is fixedly fitted with the back end of the robotic fingers in the circumferential direction. The palm support and the fixed arm are hinged through a motor shaft of the third servo motor with a single degree of freedom to form a wrist joint. The housing of the third servo motor is fixed to the fixed arm. The motor shaft of the third servo motor is fixedly fitted with the palm support in the circumferential direction. A back end of the palm rods is hinged on the palm support through a motor shaft of the fourth servo motor with a single degree of freedom in a manner enabling rotation in the plane on which the palm is positioned. The housing of the fourth servo motor is fixed to the palm support. The motor shaft of the fourth servo motor is fixedly fitted with the back end of the palm rods in the circumferential direction.

As a preferred technical solution, in adjacent knuckles of the robotic fingers, one end of the knuckle is provided with a longitudinal hinge groove. Another end of the knuckle is embedded in the hinge groove and hinged thereto. A front end of the fixed arm is provided with a fixed arm hinge groove. The palm support is provided with a longitudinal protrusion backward. The longitudinal protrusion is embedded in the fixed arm and hinged thereto. The palm support is provided with a finger hinge groove. The back end of the robotic fingers is embedded into the finger hinge groove and hinged thereto.

Compared with the prior art, the advantageous effects of the present invention are:

(1) It is designed with multiple training modes, which can assist patients to perform the following hand movements: grasping actively and passively, pinching with the thumb and index finger, and gripping with the thumb, index finger and middle finger;
(2) The present invention adopts a structure which corresponds to a human hand. During the rehabilitation process, the finger joints and wrist joints are guided to perform corresponding movements in all degrees of freedom that a human hand has. While exercising the joints, the invention helps reduce the formation of scars, maximize skin elasticity, and therefore restore the functions of a recovered palm back to normal. During treatment, the fingers can be separated by a variable distance. At the same time, the formation of webbed scars between fingers can be reduced or suppressed, retaining the function of the hand to the maximum extent. The use of thick gauze to wrap the fingers is avoided to prevent prolonged recovery of the burned finger skin due to low breathability. The treatment cost is reduced as the pain of the burned patient is relieved;
(3) In the present invention, the collar is disposed below the finger joint so that the patient is not blocked by the device during flexion and extension, and finger injuries will not be caused, which is more conducive to the flexion and extension of the patient's finger, achieving a better flexion and extension effect;
(4) In the present invention, the finger abduction force detection sensor detects the pressure on the outer side surface of a finger when the finger is extended, and is used for detecting the movement intention of a patient to actively extend the finger. The finger flexion force detection sensor detects the pressure on the inner side surface of a finger when the finger flexes, and is used for detecting the movement intention of a patient to actively flex the finger;
(5) In the present invention, the main controller drives the hand to move according to a preset movement range and the signals of a displacement sensor embedded in the servo motors. When in the active rehabilitation training mode, the main controller implements data acquisition of the finger abduction force detection sensor and the finger flexion force detection sensor, and determines the movement intention of the finger according to the acquired signals, thereby driving the servo motors to extend or retract accordingly.

### BRIEF DESCRIPTION OF THE DRAWINGS

FIG. 1 is a view showing the overall structure of the multifunctional hand rehabilitation training device according to the present invention.

FIG. 2 is a longitudinal sectional view showing a knuckle of the multifunctional hand rehabilitation training device of the present invention.

FIG. 3 is a longitudinal sectional view showing a palm rod of the multifunctional hand rehabilitation training device according to the present invention.

FIG. 4 is a view showing the structure of a collar of the multifunctional hand rehabilitation training device according to the present invention.

FIG. 5 is a view showing the structure of the control system of the finger rehabilitation robotic hand of the multifunctional hand rehabilitation training device according to the present invention.

FIG. 6 is a main flow chart showing the control of the finger rehabilitation robotic hand of the multifunctional hand rehabilitation training device according to the present invention.

FIG. 7 is a flow chart showing the control of the passive mode of the finger rehabilitation robotic hand of the multifunctional hand rehabilitation training device according to the present invention.

FIG. 8 is a flow chart showing the control of the active mode of the finger rehabilitation robotic hand of the multifunctional hand rehabilitation training device according to the present invention.

FIG. 9 is a flow chart showing the printing mode of the finger rehabilitation robotic hand of the multifunctional hand rehabilitation training device according to the present invention.

The labels in the drawings are as follows: 1. knuckle, 2. first servo motor, 3. collar, 4. screw, 5. second servo motor, 6. palm rod, 7. fourth servo motor, 8. palm support, 9. fixed arm, 10. fixing ring, 11. fixing ring screw, 12. third servo motor, 13. controller, 14. display, 15. printing output device, 16. power source, 1a. outer sleeve, 1b. inner sleeve, 1c. locking screw, 3a. flexible thin layer, 17. finger abduction force detection sensor, 18. finger flexion force detection sensor.

### DETAILED DESCRIPTION

The present invention will be further described in detail below with reference to the accompanying drawings and embodiments. It should be understood that the specific embodiments described herein are merely illustrative of the invention and are not intended to limit the invention.

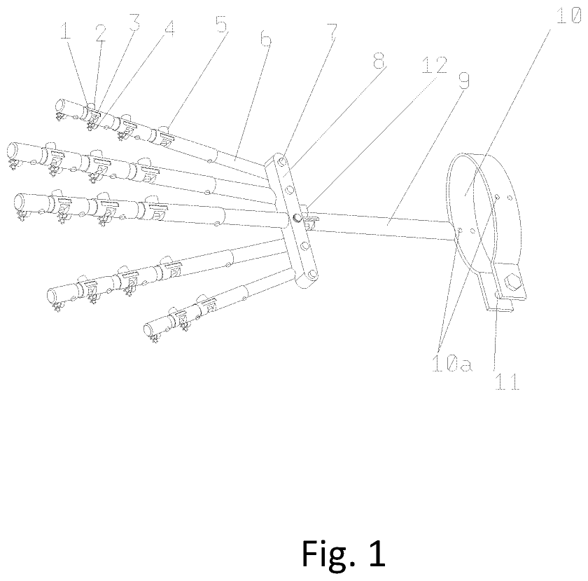

In conjunction with FIG. 1 to FIG. 8: A multifunctional hand rehabilitation training device comprises robotic fingers, palm rods 6, a robotic wrist and a power control system.

The robotic fingers correspond to human fingers. Each robotic finger comprises knuckles 1. Adjacent knuckles 1 are hinged with a single degree of freedom to form a finger joint. Each finger joint is provided with a first servo motor 2 which drives the knuckles 1 to rotate about the hinge axis. Each knuckle 1 is provided thereon with a collar 3 for fitting over the knuckle 1 of a human finger.

In conjunction with FIG. 1, the palm rods 6 correspond to the robotic fingers. The number of robotic fingers is five, and the number of palm rods is also five. A front end of each palm rods 6 is hinged to a back end with a single degree of freedom to form a whole finger joint. Each whole finger joint is provided with a second servo motor which drives the robotic fingers to rotate about the hinge axis. As shown in the figure, five robotic fingers (corresponding to human fingers) have nine finger joints, five whole finger joints, nine corresponding first servo motors and five second servo motors.

The robotic wrist comprises a palm support 8 and a fixed arm 9. The palm support 8 and the fixed arm 9 are hinged with a single degree of freedom to form a wrist joint. The wrist joint is provided with a third servo motor 12 which drives the palm support 8 to rotate about the hinge axis. The fixed arm 9 is provided thereon with a fixing ring 10 for fixing the fixed arm 9 onto a human arm.

A back end of the palm rods 6 is hinged on the palm support 8 with a single degree of freedom in a manner enabling rotation in the plane on which the palm is positioned, and is provided with a fourth servo motor 7 which drives the palm rods 6 to rotate about the hinge axis.

The first servo motor 2, the second servo motor 5, the third servo motor 12 and the fourth servo motor 7 pass through the power control system.

The left and right ends of the collar 3 are respectively provided with a finger abduction force detection sensor 17 and a finger flexion force detection sensor 18.

The power control system comprises a main controller connected to the first servo motor 2, the second servo motor 5, the third servo motor 12 and the fourth servo motor 7. The STM32F107VC under the ARM-Cortex-M3 architecture is used as the main controller. The STM32F107 has a full-speed USD (OTG) interface, a duplex CAN2.0B interface and an Ethernet 10/100MAC module. The main controller implements the acquisition of signals fed back by a fingertip outer side pressure sensor, a fingertip inner side pressure sensor and a linear sensor embedded in the first servo motor 2, the second servo motor 5, the third servo motor 12 and the fourth servo motor 7, and driving the first servo motor 2, the second servo motor 5, the third servo motor 12 and the fourth servo motor 7 to move according to the acquired signals. A signal conditioning unit in the main controller is used for processing signals from the fingertip outer side pressure sensor, fingertip inner side pressure sensor and a displacement sensor embedded in the first servo motor 2, the second servo motor 5, the third servo motor 12 and the fourth servo motor 7, performing corresponding amplification and filtering of the sensor signals, and sending them to an acquisition board for data acquisition. The displacement signals fed back are analog signals. The angle at which the finger is currently flexing is calculated.

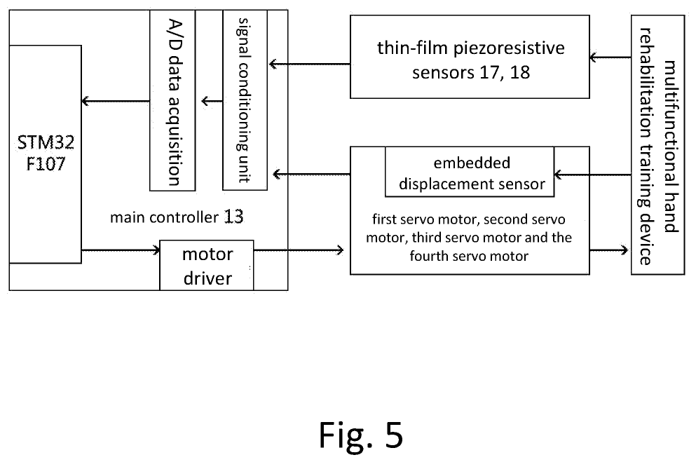

In conjunction with FIG. 5, a thin-film piezoresistive sensor is used as the finger abduction force detection sensor 17 and the finger flexion force detection sensor 18.

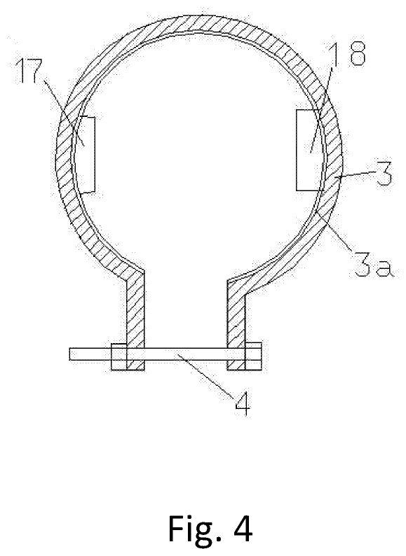

In conjunction with FIG. 4, in the embodiment, the inner circular surface of the collar 3 is provided with a flexible thin layer 3a. A silicone layer can be used. The flexible thin layer is in contact with the skin of a human finger wrapped in a thin layer of gauze, which can effectively protect the skin.

As shown in FIG. 4, the structure of the fixing ring and the structure of the collar are the same in the technical solution, but the diameters are different. The screw 4 on the collar can be directly screwed on the bent portions by threads, and can directly pass the bent portions to be locked tight by a nut and adjust the diameter of the collar. The structure of the collar of the embodiment can adjust the diameter of the collar by the collar screw to be adapted for fingers of different sizes, providing the present invention with greater versatility. The fixing ring is of an open ring structure. Both sides of the opening are bent outward to form two bent portions. A fixing ring screw is disposed through the two bent portions for sealing and adjusting the diameter of the collar. The structure of the fixing ring 10 of the embodiment can adjust the diameter of the fixing ring by the fixing ring screw 11 to be adapted for fixation on different arms, further providing the present invention with greater versatility.

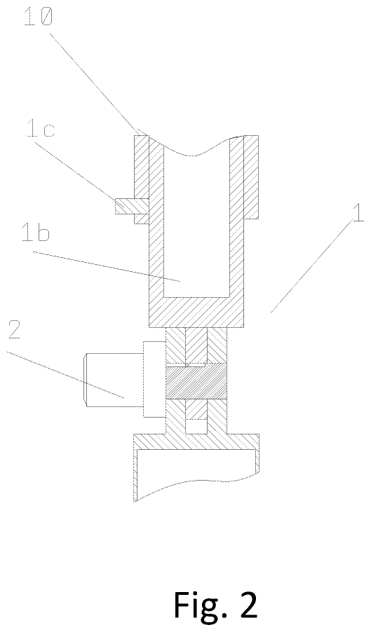

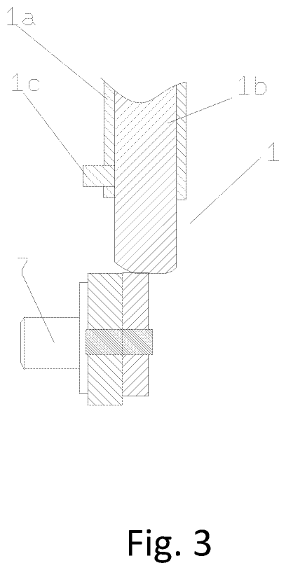

In conjunction with FIG. 2 and FIG. 3, in the embodiment, the knuckles 1 of the robotic fingers and the palm rods 6 are of a telescopic structure composed of sleeves. The sleeves comprise an inner sleeve and an outer sleeve, provided with a locking screw screwing through the outer sleeve in the radial direction. As shown in the figure, the knuckle 1 comprises an inner sleeve 1b and an outer sleeve 1a. A locking screw 1c screws through the outer sleeve 1a to abut against the outer surface of the inner sleeve 1b. The palm rod 6 comprises an inner sleeve 1b and an outer sleeve 1a. A locking screw 1c screws through the outer sleeve 1a to abut against the outer surface of the inner sleeve 1b. In the embodiment, the lengths of the knuckles 1 and the palm rods 6 are adjustable to be adapted for palms of different sizes, further providing the present invention with greater versatility.

In conjunction with FIG. 4, the fixed arm 9 is fixedly connected to the fixing ring 10 in a removable manner. The fixing ring 10 is provided with two opposite connecting portions in the radial direction for fixed connection with the fixed arm 9.

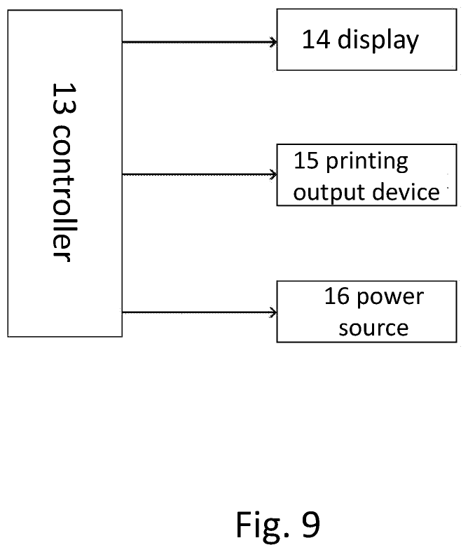

In conjunction with FIG. 9, in the embodiment, the control system further comprises a display 14 for displaying information of the first servo motor 2, the second servo motor 5, the third servo motor 12 and the fourth servo motor 7, and a printing output device 15. The first servo motor 2, the second servo motor 5, the third servo motor 12 and the fourth servo motor 7 are connected to the power source through a controller 13. The movement parameters of each joint are instantly observed and printed out.

In conjunction with FIG. 1, in the embodiment, adjacent knuckles 1 of the robotic fingers are hinged through a motor shaft of the first servo motor 2 with a single degree of freedom to form a finger joint. The housing of the first servo motor 2 is fixed to one of the knuckles 1. The motor shaft of the first servo motor 2 is fixedly fitted with another knuckle 1 in the circumferential direction. A front end of the palm rods 6 and a back end of the corresponding robotic fingers are hinged through a motor shaft of the second servo motor 5 with a single degree of freedom to form a whole finger joint. The housing of the second servo motor 5 is fixed to the palm rods 6. The motor shaft of the second servo motor 5 is fixedly fitted with the back end of the robotic fingers in the circumferential direction. The palm support 8 and the fixed arm 9 are hinged through a motor shaft of the third servo motor 12 with a single degree of freedom to form a wrist joint. The housing of the third servo motor 12 is fixed to the fixed arm 9. The motor shaft of the third servo motor 12 is fixedly fitted with the palm support 8 in the circumferential direction. A back end of the palm rods 6 is hinged on the palm support 8 through a motor shaft of the fourth servo motor 7 with a single degree of freedom in a manner enabling rotation in the plane on which the palm is positioned. The housing of the fourth servo motor 7 is fixed to the palm support 8. The motor shaft of the fourth servo motor 7 is fixedly fitted with the back end of the palm rods 6 in the circumferential direction. A hinge structure is formed through a motor shaft, which makes the present invention compactly structured and easy to install and remove.

In conjunction with FIG. 1, in the embodiment, in the adjacent knuckles 1 of the robotic fingers, one end of the knuckle 1 is provided with a longitudinal hinge groove. Another end of the knuckle 1 is embedded in the hinge groove and hinged thereto. A front end of the fixed arm 9 is provided with a fixed arm 9 hinge groove. The palm support 8 is provided with a longitudinal protrusion backward. The longitudinal protrusion is embedded in the fixed arm 9 and hinged thereto. The palm support 8 is provided with a finger hinge groove.

The back end of the robotic fingers is embedded into the finger hinge groove and hinged thereto. Hinging is carried out by the hinge groove structure, which can better define the degree of freedom between the knuckles and between the robotic fingers and the palm support, conforming to the principle of human bionics.

When the present invention is in the passive rehabilitation mode, the main controller drives the hand to move according to a preset movement range and the signals of a displacement sensor embedded in the first servo motor, the second servo motor, the third servo motor and the fourth servo motor. When the present invention is in the active rehabilitation training mode, the main controller implements data acquisition of the finger abduction force detection sensor and the finger flexion force detection sensor, and determines the movement intention of the finger according to the acquired signals, thereby driving the first servo motor, the second servo motor, the third servo motor and the fourth servo motor to extend or retract accordingly.

### The Working Principle of the Present Invention:

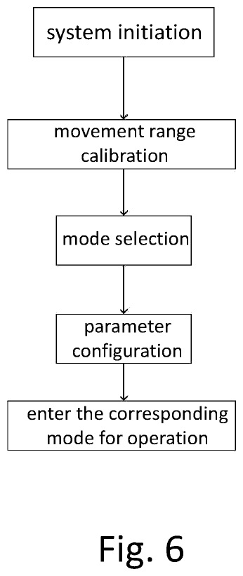

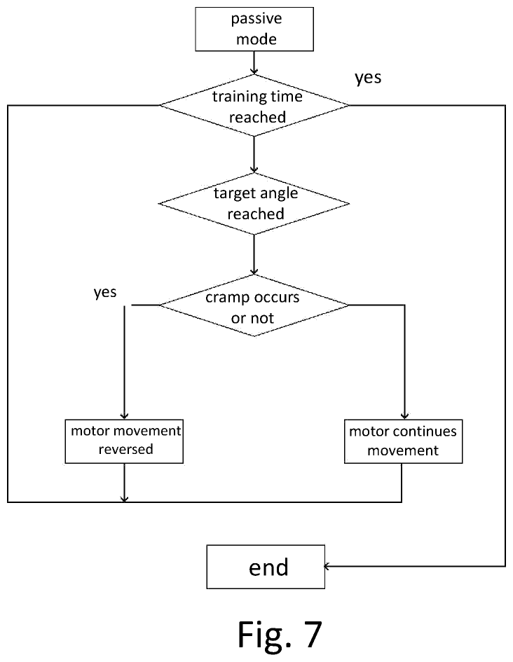

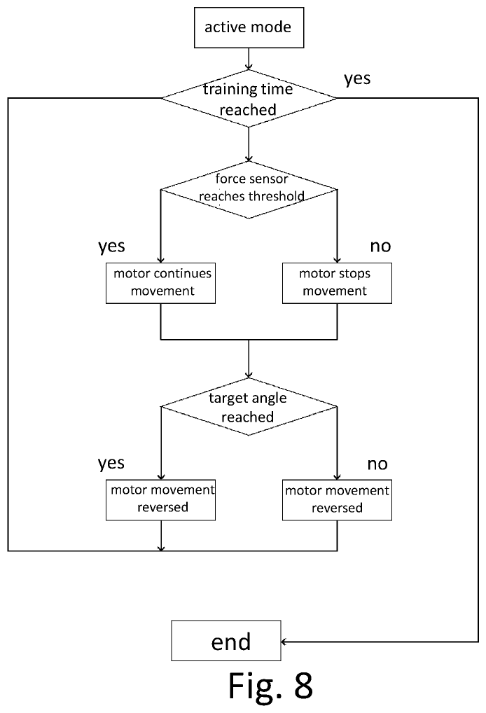

The control mode of the multifunctional hand rehabilitation training device according to the present invention is shown in FIG. 6, and it has two working modes: passive mode and active assistance/resistance mode. The flow charts of the two modes are shown in FIG. 7 and FIG. 8 respectively. The passive mode is suitable for patients in the early stage of stroke who lack muscle strength. The fingers are driven by a robotic hand for flexion and extension training. When a patient wears the hand rehabilitation device, the displacement sensor disposed in the determination motor determines whether the hand has reached the set target angle, thereby determining whether the direction of movement should be reversed. During the movement of the patient's hand, if a cramp occurs, the motor moves in the reverse direction to relieve the cramp. It is also possible to monitor the training time by counting the time with a timer inside the controller.

The active assistance/resistance mode is suitable for stroke patients in the stage of recovery, who have a certain level of muscle strength. When the patient performs a voluntary finger flexion movement, the output signal of the fingertip inner side pressure sensor is detected to determine whether the set force has been reached. If so, a push rod in the motor will extend a certain distance such that the patient needs to keep flexing to ensure that the output signal of the fingertip inner side pressure sensor reaches the set threshold. Only by doing so can the finger flexion movement be completed. When the patient performs a voluntary finger extension movement, the output of the fingertip outer side pressure sensor is detected. The voluntary extension movement is completed in a similar manner as described above.

The present invention is designed with multiple training modes, which can assist patients to perform the following hand movements: grasping actively and passively, pinching with the thumb and index finger, and gripping with the thumb, index finger and middle finger. The present invention adopts a structure which corresponds to a human hand. During the rehabilitation process, the finger joints and wrist joints are guided to perform corresponding movements in all degrees of freedom that a human hand has. While exercising the joints, the invention helps reduce the formation of scars, maximize skin elasticity, and therefore restore the functions of a recovered palm back to normal. During treatment, the fingers can be separated by a variable distance. At the same time, the formation of webbed scars between fingers can be reduced or suppressed, retaining the function of the hand to the maximum extent. The use of thick gauze to wrap the fingers is avoided to prevent prolonged recovery of the burned finger skin due to low breathability. The treatment cost is reduced as the pain of the burned patient is relieved.

In the present invention, the collar is disposed below the finger joint so that the patient is not blocked by the device during flexion and extension, and finger injuries will not be caused, which is more conducive to the flexion and extension of the patient's finger, achieving a better flexion and extension effect.

In the present invention, the finger abduction force detection sensor detects the pressure on the outer side surface of a finger when the finger is extended, and is used for detecting the movement intention of a patient to actively extend the finger. The finger flexion force detection sensor detects the pressure on the inner side surface of a finger when the finger flexes, and is used for detecting the movement intention of a patient to actively flex the finger.

The main controller of the present invention drives the hand to move according to a preset movement range and the signals of a displacement sensor embedded in the servo motors. When in the active rehabilitation training mode, the main controller implements data acquisition of the finger abduction force detection sensor and the finger flexion force detection sensor, and determines the movement intention of the finger according to the acquired signals, thereby driving the servo motors to extend or retract accordingly.

In the description of the present invention, it shall be understood that terms such as “one end”, “front upper”, “end”, “length”, “width”, “inner”, “upper”, “other end”, “both ends”, “horizontal”, “coaxial”, “bottom” and “lower” indicate the orientation or positional relationship based on the orientation or positional relationship shown in the drawings, which is only for the convenience of describing the present invention and simplifying the description, but not indicating or implying that the device or component that is referred to should have a particular orientation, and be constructed and operated in a particular orientation, and therefore shall not be construed as limiting the present invention.

In the present invention, unless otherwise expressly specified and defined, terms such as “configured”, “engaged”, “connected”, “embedded” and “covered” should be understood broadly, and may be referring to, for example, a fixed connection, a removable connection, or an integrated connection. It can be a mechanical connection or an electrical connection. It can be a direct connection, an indirect connection through an intermediate medium, an internal communication between two elements or an interaction relationship between two elements, unless otherwise expressly defined. The specific meaning of the above terms in the present invention can be understood by those skilled in the art according to specific situations.

The above description includes only the preferred embodiments of the present invention, and is not intended to limit the scope of the present invention. Equivalent structural transformations of the contents of the specification of the present invention, or direct or indirect applications to the technical field of related products shall fall within the protection scope of the present invention.

What is claimed is:

1. A multifunctional hand rehabilitation training device, characterized in that, comprising robotic fingers, palm rods (6), a robotic wrist and a power control system;
the robotic fingers correspond to human fingers, each robotic finger comprising knuckles (1), adjacent knuckles hinged with a single degree of freedom to form a finger joint, each finger joint provided with a first servo motor (2) which drives the knuckles (1) to rotate about the hinge axis: each knuckle (1) is provided thereon with a collar (3) for fitting over the knuckle (1) of a human finger;
the palm rods (6) correspond to the robotic fingers, a front end of each palm rods (6) hinged to a back end of the robotic fingers with a single degree of freedom to form a whole finger joint, each whole finger joint provided with a second servo motor which drives the robotic fingers to rotate about the hinge axis;
the robotic wrist comprises a palm support (8) and a fixed arm (9), the palm support (8) and the fixed arm (9) hinged with a single degree of freedom to form a wrist joint, the wrist joint provided with a third servo motor (12) which drives the palm support (8) to rotate about the hinge axis; the fixed arm (9) is provided thereon with a fixing ring (10) for fixing the fixed arm (9) onto a human arm;
a back end of the palm rods (6) is hinged on the palm support (8) with a single degree of freedom in a manner enabling rotation in the plane on which the palm is positioned, and is provided with a fourth servo motor (7) which drives the palm rods (6) to rotate about the hinge axis;
the first servo motor (2), the second servo motor (5), the third servo motor (12) and the fourth servo motor (7) pass through the power control system;
the left and right ends of the collar (3) are respectively provided with a finger abduction force detection sensor (17) and a finger flexion force detection sensor (18);
the power control system comprises a main controller connected to the first servo motor (2), the second servo motor (5), the third servo motor (12) and the fourth servo motor (7), the STM32F107VC under the ARM-Cortex-M3 architecture used as the main controller, the STM32F107 having a full-speed USD (OTG) interface, a duplex CAN2.0B interface and an Ethernet 10/100MAC module, the main controller implementing the acquisition of signals fed back by a fingertip outer side pressure sensor, a fingertip inner side pressure sensor and a linear sensor embedded in the first servo motor (2), the second servo motor (5), the third servo motor (12) and the fourth servo motor (7), and driving the first servo motor (2), the second servo motor (5), the third servo motor (12) and the fourth servo motor (7) to move according to the acquired signals; a signal conditioning unit in the main controller is used for processing signals from the fingertip outer side pressure sensor, the fingertip inner side pressure sensor and a displacement sensor embedded in the first servo motor (2), the second servo motor (5), the third servo motor (12) and the fourth servo motor (7), and sending the processed signals to an acquisition board for data acquisition.

2. The multifunctional hand rehabilitation training device according to claim 1, characterized in that: a thin-film piezoresistive sensor is used as the finger abduction force detection sensor (17) and the finger flexion force detection sensor (18).

3. The multifunctional hand rehabilitation training device according to claim 1, characterized in that: the inner circular surface of the collar (3) is provided with a flexible thin layer (3a).

4. The multifunctional hand rehabilitation training device according to claim 1, characterized in that: the collar (3) and fixing ring (10) are of an open ring structure, both sides of the opening bent outward to form two bent portions, a screw (4) disposed through the two bent portions for sealing and adjusting the diameter of the collar (3): the fixing ring (10) is of an open ring structure, both sides of the opening bent outward to form two bent portions, a fixing ring (10) screw (4) disposed through the two bent portions for sealing and adjusting the diameter of the fixing ring (10).

5. The multifunctional hand rehabilitation training device according to claim 1, characterized in that: the knuckles (1) of the robotic fingers and the palm rods (6) are of a telescopic structure composed of sleeves, the sleeves comprising an inner sleeve (1b) and an outer sleeve (1a), provided with a locking screw (1c) screwing through the outer sleeve (1a) in the radial direction.

6. The multifunctional hand rehabilitation training device according to claim 1, characterized in that: the fixed arm (9) is fixedly connected to the fixing ring (10) in a removable manner, the fixing ring (10) provided with two opposite connecting portions in the radial direction for fixed connection with the fixed arm (9).

7. The multifunctional hand rehabilitation training device according to claim 1, characterized in that: the control system further comprises a display (14) for displaying information of the first servo motor (2), the second servo motor (5), the third servo motor (12) and the fourth servo motor (7), and a printing output device (15); the first servo motor (2), the second servo motor (5), the third servo motor (12) and the fourth servo motor (7) are connected to the power source through a controller (13).

8. The multifunctional hand rehabilitation training device according to claim 1, characterized in that: adjacent knuckles (1) of the robotic fingers are hinged through a motor shaft of the first servo motor (2) with a single degree of freedom to form a finger joint, the housing of the first servo motor (2) fixed to one of the knuckles (1), the motor shaft of the first servo motor (2) fixedly fitted with another knuckle (1) in the circumferential direction; a front end of the palm rods (6) and a back end of the corresponding robotic fingers are hinged through a motor shaft of the second servo motor (5) with a single degree of freedom to form a whole finger joint, the housing of the second servo motor (5) fixed to the palm rods (6), the motor shaft of the second servo motor (5) fixedly fitted with the back end of the robotic fingers in the circumferential direction; the palm support (8) and the fixed arm (9) are hinged through a motor shaft of the third servo motor (12) with a single degree of freedom to form a wrist joint; the housing of the third servo motor (12) is fixed to the fixed arm (9), the motor shaft of the third servo motor (12) fixedly fitted with the palm support (8) in the circumferential direction; a back end of the palm rods (6) is hinged on the palm support (8) through a motor shaft of the fourth servo motor (7) with a single degree of freedom in a manner enabling rotation in the plane on which the palm is positioned, the housing of the fourth servo motor (7) fixed to the palm support (8), the motor shaft of the fourth servo motor (7) fixedly fitted with the back end of the palm rods (6) in the circumferential direction.

9. The multifunctional hand rehabilitation training device according to claim 8, characterized in that: in the adjacent knuckles (1) of the robotic fingers, one end of the knuckle (1) is provided with a longitudinal hinge groove, another end of the knuckle (1) embedded in the hinge groove and hinged thereto; a front end of the fixed arm (9) is provided with a fixed arm (9) hinge groove, the palm support (8) provided with a longitudinal protrusion backward, the longitudinal protrusion embedded in the fixed arm (9) and hinged thereto; the palm support (8) is provided with a finger hinge groove, the back end of the robotic fingers embedded into the finger hinge groove and hinged thereto.
